(19) United States
(12) Patent Application Publication
(10) Pub. No.: US 2013/0175168 A1
(43) Pub. Date: Jul. 11, 2013

(54) Microelectrode Assemblies and Associated Electrochemical Sensors for Use in Gas and or Fire Detection Devices

(71) Applicant: Gentex Corporation, Zeeland, MI (US)

(72) Inventor: Joel C. Nemes, Holland, MI (US)

(73) Assignee: GENTEX CORPORATION, Zeeland, MI (US)

(21) Appl. No.: 13/780,978

(22) Filed: Feb. 28, 2013

Related U.S. Application Data
(63) Continuation-in-part of application No. 12/804,977, filed on Aug. 3, 2010.
(60) Provisional application No. 61/231,229, filed on Aug. 4, 2009.
(60) Provisional application No. 61/604,599, filed on Feb. 29, 2012.

(51) Int. Cl. G01N 27/407

(52) U.S. Cl. CPC G01N 27/4074
USPC 204/415

(57) ABSTRACT

An electrochemical carbon monoxide sensor that is optionally tankless and/or reservoir free for use in a gas/fire detector having a housing for containing a micro electrode assembly therein, and a micro electrode assembly which includes an anode, a cathode and an ion conducting membrane, wherein the ion conducting membrane permits ion transport between the anode and the cathode, and wherein the ion conducting membrane prevents electron conduction between the anode and the cathode, and further wherein the ion conducting membrane comprises at least one of an acid doped polybenzimidazole, an acid doped polypyridylbenzimidazole, a protic ionic liquid doped polybenzimidazole, a protic ionic liquid doped sulfonated polyimide, and combinations thereof.

### CROSS-REFERENCE TO RELATED APPLICATIONS

This application is a continuation-in-part of U.S. patent application Ser. No. 12/804,977, filed Aug. 3, 2010, entitled “CATHODIC MATERIALS FOR USE IN ELECTROCHEMICAL SENSORS AND ASSOCIATED DEVICES AND METHODS OF MANUFACTURING THE SAME,” now United States Patent Application Publication Number 2011/0048943, which claims the benefit of U.S. Provisional Patent Application Ser. No. 61/231,229, filed Aug. 4, 2009, entitled “CATHODIC MATERIALS FOR USE IN ELECTROCHEMICAL SENSORS AND ASSOCIATED DEVICES,” and this application also claims the benefit of U.S. Provisional Patent Application Ser. No. 61/604,599, filed Feb. 29, 2012, entitled “MICROELECTRODE ASSEMBLIES AND ASSOCIATED ELECTROCHEMICAL SENSORS FOR USE IN GAS AND/OR FIRE DETECTION DEVICES,” all of which are hereby incorporated herein by reference in their entirety—including all references cited therein.

### BACKGROUND OF THE INVENTION

1. Field of the Invention

The present invention relates in general to microelectrode assemblies and associated electrochemical sensors for use in gas and/or fire detection devices and, more particularly, to novel microelectrode assembly configurations and electrochemical sensors which are reservoir free (e.g., tankless, button cell, coin cell, etcetera) and/or optionally comprise a reservoir. The present invention further relates to electrochemical sensors that comprise novel ion conducting membrane configurations.

2. Background Art

Electrochemical sensors for use in, for example, gas and/or fire detectors have been known in the art for several years. See, for example, U.S. Pat. No. 4,329,214 entitled “Gas Detection Unit,” U.S. Pat. No. 5,302,274 entitled “Electrochemical Gas Sensor Cells Using Three Dimensional Sensing Electrodes,” U.S. Pat. No. 5,331,310 entitled “Amperometric Carbon Monoxide Sensor Module for Residential Alarms,” U.S. Pat. No. 5,573,648 entitled “Gas Sensor Based on Protonic Conductive Membranes,” U.S. Pat. No. 5,618,493 entitled “Photon Absorbing Bioderived Organometallic Carbon Monoxide Sensors,” U.S. Pat. No. 5,650,054 entitled “Low Cost Room Temperature Electrochemical Carbon Monoxide and Toxic Gas Sensor with Humidity Compensation Based on Protonic Conductive Membranes,” U.S. Pat. No. 5,944,969 entitled “Electrochemical Sensor With A Non-Aqueous Electrolyte System,” U.S. Pat. No. 5,958,200 entitled “Electrochemical Gas Sensor,” U.S. Pat. No. 6,172,759 entitled “Target Gas Detection System with Rapidly Regenerating Optically Responding Sensors,” U.S. Pat. No. 6,200,443 entitled “Gas Sensor with a Diagnostic Device,” U.S. Pat. No. 6,936,147 entitled “Hybrid Film Type Sensor,” U.S. Pat. No. 6,948,352 entitled “Self-Calibrating Carbon Monoxide Detector and Method,” U.S. Pat. No. 7,077,938 entitled “Electrochemical Gas Sensor,” U.S. Pat. No. 7,022,213 entitled “Gas Sensor and Its Method of Manufacture,” U.S. Pat. No. 7,236,095 entitled “Solid State Sensor for Carbon Monoxide,” U.S. Pat. No. 7,279,081 entitled “Electrochemical Sensor,” U.S. Patent Publication No. 2005/0145494 entitled “Liquid Electrochemical Gas Sensor,” U.S. Patent Publication No. 2006/0091007 entitled “Gas Detecting Device with Self-Diagnosis for Electrochemical Gas Sensor,” U.S. Patent Publication No. 2006/0120924 entitled “Proton Conductor Gas Sensor,” and U.S. Patent Publication No. 2006/0196770 entitled “Liquid Electrochemical Gas Sensor,” all of which are hereby incorporated herein by reference in their entirety—including all references cited therein.

While the utilization of electrochemical sensors for use in gas and/or fire detectors has become increasingly popular, sensor performance, cost, longevity, and/or configuration remains largely problematic.

Indeed, modern electrochemical sensors commonly use carbon supported noble metal catalysts, such as platinum at both the anode and the cathode. At the anode, platinum typically catalyzes the oxidation of the fuel, such as hydrogen, methanol, carbon monoxide, etcetera. At the cathode, platinum typically catalyzes the reduction of oxygen. For example, the chemical reactions that typically occur in an electrochemical carbon monoxide sensor are provided below:

Anode: CO+H₂O→CO₂+2H⁺+2e⁻

Cathode: ½O₂+2H⁺+2e⁻→H₂O

Net: CO+½O₂→CO₂

As is shown in reaction form above and in FIG. 1, current electrochemical carbon monoxide sensors typically include: (1) an anode that oxidizes carbon monoxide to carbon dioxide, (2) a cathode that reduces atmospheric oxygen to water, and (3) an ion exchange membrane (i.e., an ion conductor) that shuttles ions (e.g., H⁺, OH⁻, etcetera) between the anode and the cathode. Normally, the current generated by this reaction is approximately proportional to the amount of carbon monoxide present.

In an attempt to maintain both high and consistent ionic conductivity, the ion exchange membranes used in traditional electrochemical carbon monoxide sensors normally require the presence of an internal supply of water or hygroscopic acid to facilitate a requisite humidity or concentration of water vapor in the sensor. Inasmuch as carbon monoxide sensors operate in an open environment for purposes of sampling ambient gas, the internal water supply is subject to fluctuations in environmental humidity and therefore evaporation over time. When complete internal water evaporation occurs, a material drop in conductivity of the ion exchange membrane can lead to a loss of sensitivity to carbon monoxide, among other gases, as well as a shortened lifetime of the sensor. Furthermore, in certain high humidity environments when a hygroscopic acid is used, excessive absorption of water can occur, which can result in undesired leakage of corrosive acid onto the electronics of an associated detector.

It is therefore an object of the present invention, among other objects, to provide novel ion exchange membrane (i.e., ion conducting membrane) configurations for use in microelectrode assemblies which maintain a requisite level of conductivity adequate for an associated sensor at all levels of humidity during normal use and, therefore, does not require an internal water supply. It is also an object of the present invention to provide novel microelectrode assembly configurations and tankless electrochemical sensors which are reservoir free (i.e., tankless) and/or optionally comprise a reservoir.

These and other objects of the present invention will become apparent in light of the present specification, claims, and appended drawings.

### SUMMARY OF THE INVENTION

In one embodiment the present invention is directed to an electrochemical carbon monoxide sensor comprising: (a) at least one housing member, and (b) a microelectrode assembly, wherein the electrochemical sensor is tankless and/or reservoir free. In this embodiment the electrochemical carbon monoxide sensor preferably comprises a button cell or coin cell.

The present invention is also directed to an electrochemical carbon monoxide sensor for use in a gas/fire detector comprising: (a) a housing, wherein the housing comprises a first sidewall, a second sidewall, a top wall, and a bottom wall, and wherein the first sidewall, the second sidewall, the top wall and the bottom wall define a containment region for containing a micro electrode assembly therein, and further wherein the top wall of the housing comprises a gaseous diffusion aperture; and (b) a micro electrode assembly which comprises an anode, a cathode and an ion conducting membrane, wherein the ion conducting membrane permits ion transport between the anode and the cathode, and wherein the ion conducting membrane prevents electron conduction between the anode and the cathode, and further wherein the ion conducting membrane comprises one or more of an acid doped polybenzimidazole, an acid doped polypyridylbenzimidazole, a protic ionic liquid doped polybenzimidazole, a protic ionic liquid doped sulfonated polyimide, and combinations thereof.

In a preferred embodiment of the present invention, the ion conducting membrane comprises the structure of formula I doped with H₃PO₄:

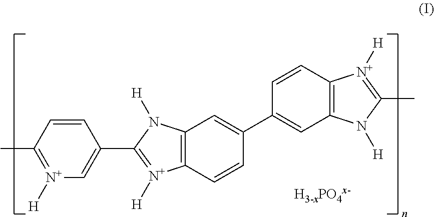

wherein n is an integer ranging in value from 1 to approximately 10,000.

In another preferred embodiment of the present invention, the ion conducting membrane comprises the structure of formula II doped with H₃PO₄:

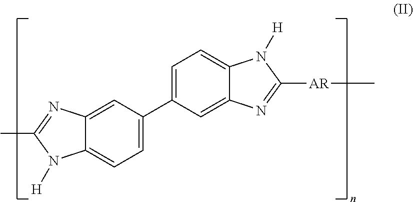

wherein AR comprises at least one of the structures of formulas a-e:

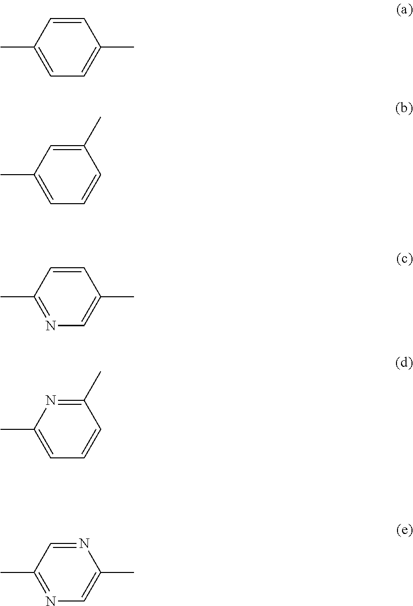

and wherein n is an integer ranging in value from 1 to approximately 10,000.

In yet another preferred embodiment of the present invention, the ion conducting membrane comprises the structure of formula III doped with H₃PO₄:

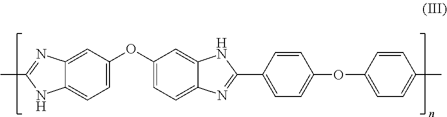

wherein n is an integer ranging in value from 1 to approximately 10,000.

In one aspect of the present invention, the ion conducting membrane comprises the structure of formula IV doped with H₃PO₄:

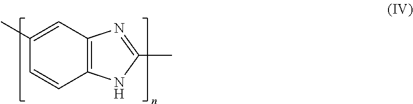

wherein n is an integer ranging in value from 1 to approximately 10,000.

In another aspect of the present invention, the ion conducting membrane comprises the structure of formula V doped with H₃PO₄:

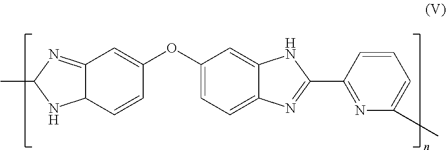

wherein n is an integer ranging in value from 1 to approximately 10,000.

In the aforementioned embodiments, the electrochemical sensors are preferably tankless and/or reservoir free (e.g., button cell and/or coin cell configurations).

In a preferred embodiment of the present invention, the anode and the cathode are disposed upon the same side and/or opposite sides of the ion conducting membrane, and/or exposed to a same gaseous environment.

The present invention is further directed to an electrochemical carbon monoxide sensor for use in a gas/fire detector comprising: (a) a housing, wherein the housing comprises a first sidewall, a second sidewall, a top wall, and a bottom wall, and wherein the first sidewall, the second sidewall, the top wall and the bottom wall define a containment region for containing a micro electrode assembly therein, and further wherein the top wall of the housing comprises a gaseous diffusion aperture; and (b) a micro electrode assembly which comprises an anode, a cathode and an ion conducting membrane, wherein the anode and the cathode are exposed to a same gaseous environment, and wherein the ion conducting membrane permits ion transport between the anode and the cathode, and wherein the ion conducting membrane prevents electron conduction between the anode and the cathode, and further wherein the ion conducting membrane comprises a polybenzimidazole doped with at least one of an acid, a base, and a protic ionic liquid.

The present invention is likewise directed to an electrochemical carbon monoxide sensor for use in a gas/fire detector comprising: (a) a housing, wherein the housing comprises a first sidewall, a second sidewall, a top wall, and a bottom wall, and wherein the first sidewall, the second sidewall, the top wall and the bottom wall define a containment region for containing a micro electrode assembly therein, and further wherein the top wall of the housing comprises a gaseous diffusion aperture; and (b) a micro electrode assembly which comprises an anode, a cathode and an ion conducting membrane, wherein the anode and the cathode are exposed to a same gaseous environment, and wherein the ion conducting membrane permits ion transport between the anode and the cathode, and wherein the ion conducting membrane prevents electron conduction between the anode and the cathode, and further wherein the ion conducting membrane comprises a polybenzimidazole doped with at least one of an acid, a base, and a protic ionic liquid.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a representation of a prior art electrochemical carbon monoxide sensor;

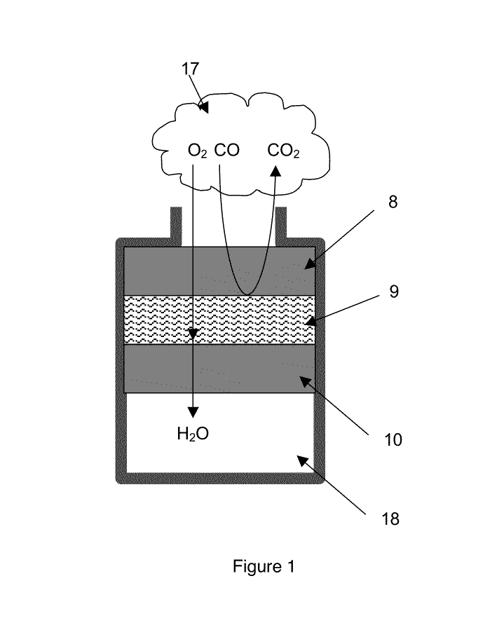

FIG. 2 of the drawings is a cross-sectional schematic representation of an electrochemical sensor fabricated in accordance with the present invention, showing among other things, a microelectrode assembly positioned between a diffusion plate and a bottom housing;

FIG. 3 of the drawings is a cross-sectional schematic representation of an electrochemical sensor with a modified top housing;

FIG. 4 of the drawings is a cross-sectional schematic representation of an electrochemical sensor fabricated in accordance with the present invention, showing among other things, components of a microelectrode assembly positioned adjacent to a diffusion plate;

FIG. 5 of the drawings are cross-sectional schematic representations of an electrochemical sensors fabricated in accordance with the present invention, showing among other things, an internal and external, expanded polytetrafluoroethylene (ePTFE) filters;

FIG. 6 of the drawings is a cross-sectional schematic representation of a gas diffusion electrode fabricated in accordance with the present invention;

FIGS. 7a-7c of the drawings are top plan, perspective, and cross-sectional schematic representations, respectively, of microelectrode assemblies fabricated in accordance with the present invention;

FIG. 8 of the drawings is a gas flow schematic of a microelectrode assembly fabricated in accordance with the present invention; and

FIG. 9 of the drawings is a plot of relative humidity (RH) versus ionic conductivity for various ion conducting membranes prepared in accordance with the present invention.

### DETAILED DESCRIPTION OF THE INVENTION

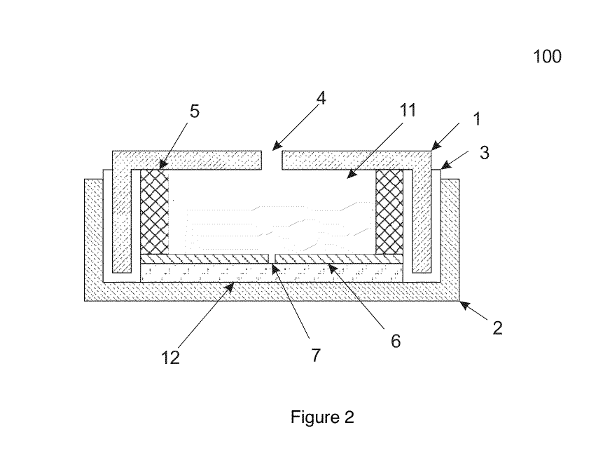

Referring now to the drawings and to FIG. 2 in particular, a cross-sectional schematic representation of button or coin cell electrochemical (EC) sensor 100 is shown, which generally comprises top and bottom housing members 1 and 2, respectively, and microelectrode assembly (MEA) 12, which as will be explained in greater detail below includes an anode, a cathode, and an ion exchange membrane. In accordance with the present invention, EC sensor 100 is reservoir free (i.e., tankless), and may optionally comprise a reservoir for containing water, solvents, electrolytes, hygroscopic acids, etcetera.

It will be understood that electrochemical sensor 100 may comprise, for illustrative purposes only, an electrochemical gas sensor for a gas and/or fire detector, and the like. It will be further understood that FIG. 2 is merely a schematic representation of electrochemical sensor 100. As such, some of the components may have been distorted from their actual scale for pictorial clarity. Indeed, numerous other electrochemical cell designs and configurations are contemplated for use, including those disclosed in U.S. Pat. No. 4,329,214 entitled “Gas Detection Unit,” U.S. Pat. No. 5,302,274 entitled “Electrochemical Gas Sensor Cells Using Three Dimensional Sensing Electrodes,” U.S. Pat. No. 5,331,310 entitled “Amperometric Carbon Monoxide Sensor Module for Residential Alarms,” U.S. Pat. No. 5,573,648 entitled “Gas Sensor Based on Protonic Conductive Membranes,” U.S. Pat. No. 5,618,493 entitled “Photon Absorbing Bioderived Organometallic Carbon Monoxide Sensors,” U.S. Pat. No. 5,650,054 entitled “Low Cost Room Temperature Electrochemical Carbon Monoxide and Toxic Gas Sensor with Humidity Compensation Based on Protonic Conductive Membranes,” U.S. Pat. No. 5,944,969 entitled “Electrochemical Sensor With A Non-Aqueous Electrolyte System,” U.S. Pat. No. 5,958,200 entitled “Electrochemical Gas Sensor,” U.S. Pat. No. 6,172,759 entitled “Target Gas Detection System with Rapidly Regenerating Optically Responding Sensors,” U.S. Pat. No. 6,200,443 entitled “Gas Sensor with a Diagnostic Device,” U.S. Pat. No. 6,936,147 entitled “Hybrid Film Type Sensor,” U.S. Pat. No. 6,948,352 entitled “Self-Calibrating Carbon Monoxide Detector and Method,” U.S. Pat. No. 7,077,938 entitled “Electrochemical Gas Sensor,” U.S. Pat. No. 7,022,213 entitled “Gas Sensor and Its Method of Manufacture,” U.S. Pat. No. 7,236,095 entitled “Solid State Sensor for Carbon Monoxide,” U.S. Pat. No. 7,279,081 entitled “Electrochemical Sensor,” U.S. Patent Publication No. 2005/0145494 entitled “Liquid Electrochemical Gas Sensor,” U.S. Patent Publication No. 2006/0091007 entitled “Gas Detecting Device with Self-Diagnosis for Electrochemical Gas Sensor,” U.S. Patent Publication No. 2006/0120924 entitled “Proton Conductor Gas Sensor,” and U.S. Patent Publication No. 2006/0196770 entitled “Liquid Electrochemical Gas Sensor,” all of which are hereby incorporated herein by reference in their entirety—including all references cited therein.

In accordance with the present invention housing members 1 and 2 are capable of containing microelectrode assembly 12 therein, and preferably include a pair of spaced apart and opposed c-shaped members, the inner walls of which cooperatively define a containment region for containing microelectrode assembly 12 therein, among other sub-components. Housing members 1 and 2 preferably comprise low profile, industry standard CRXXXX configurations, such as CR2032, CR2025, and/or CR2016 configurations. It will be understood that housing members 1 and 2 may also comprise modified versions of these housings. For purposes of the present disclosure, housing members 1 and 2 may be fabricated from one or more of any one of a number of electrically conductive materials including, for example, metals, metallic alloys (e.g., 304, 316 stainless steel), pseudo metals, metal/carbon materials, carbon materials, natural and/or synthetic plastics, and composites—all of which are optionally associated with and/or in-molded with conductive materials and/or pins—just to name a few. It will be understood that housing members 1 and 2 are preferably constructed of materials of adequate strength and thickness to limit undesirable deformation during manufacture and use.

In a preferred embodiment of the present invention, housing members 1 and 2 are individually or collectively modified to accommodate parameter requirements of the microelectrode assembly. In particular, the microelectrode assembly is normally exposed to predetermined amounts of pressure to maintain electrical contact and control the porosity of the electrodes. If the internal thickness between housing members 1 and/or 2 is too great, they can be compressed with a pneumatic press or other compression means. Typically, the amount of compression is determined by measuring the thickness of the internal components and compressing the housing members to that amount.

Although not shown, at least one of top and bottom housing members 1 and 2 preferably include electrode leads, which enable electrical communication with a sensing circuit. Suitable examples include a battery holder for a CR20XX (e.g., 2016, 2025, 2032, etcetera) style battery, and/or traditionally welded, soldered, and/or fastened tabs.

Seal member 3, facilitates controlled isolation of the containment region, and, in turn, the microelectrode assembly, from external gases. Seal member 3 preferably comprises a gas impermeable, flexible, partially flexible, and/or inflexible sealant, and/or adhesive, such as one or more natural or synthetic rubbers, a natural or synthetic adhesive resin, an epoxy resin, a plastic, such as nylon, polypropylene, etcetera and combinations thereof—just to name a few.

Top housing 1 includes gaseous diffusion aperture or inlet 4, which allows gasses external to electrochemical sensor 100 to electrochemically interact with microelectrode assembly 12.

Compression member 5 is positioned between top housing 1 and diffusion plate 6—or microelectrode assembly 12 if diffusion plate 6 is omitted or integrated into the microelectrode assembly. For purposes of the present disclosure, compression member 5 includes a spring or sponge, and maintains a prescribed amount of compression on the microelectrode assembly to ensure adequate electrical contact from the housing to the microelectrode assembly and to maintain a predetermined, desired level of porosity within the microelectrode assembly. If a washer shaped spring is utilized, with outer diameter matching the inside diameter of 1 and inner diameter of adequate size, then an activated charcoal contaminant filter, 11, can be placed inside the containment region. Non-limiting examples of suitable spring materials include metal type washers that act as a spring, such as wave springs, Belleville washers, washers of conductive silicone rubber such as silicone/oriented Monel mesh (Series 600 from Já-Bar Silicone Corporation) or carbon loaded silicone (SE65-CON from Stockwell Elastomerics, Inc.).

Diffusion plate 6 preferably covers the upper surface of microelectrode assembly 12 and comprises gaseous diffusion aperture or inlet 7, which allows gases external to electrochemical sensor 100 to electrochemically interact with microelectrode assembly 12. Preferably, the diameter of gas diffusion aperture 7 and thickness of diffusion plate 6 is controlled so as to keep the diffusion rate of sampling gas, at a desired range of measurement (e.g., approximately 30-1000 ppm) that produces an electrical current proportional to the gas concentration and prevents flooding the catalyst with too much sample gas—see for example U.S. Pat. No. 4,324,632 entitled “Gas Sensor,” which is hereby incorporated herein by reference in its entirety—including all references cited therein. Preferably, the diffusion plate is approximately 100 μM thick and includes an approximately 60-1200 diameter gaseous diffusion aperture. It will be understood that gas diffusion aperture 7 is preferably fabricated via a micro drill bit, laser ablation, or other aperture generating means. Preferably, diffusion plate 6 is fabricated from a conductive material, such as 304 stainless steel or 316 stainless steel—or any other material that generally prevents corrosion from any acid contained within the ion exchange membrane.

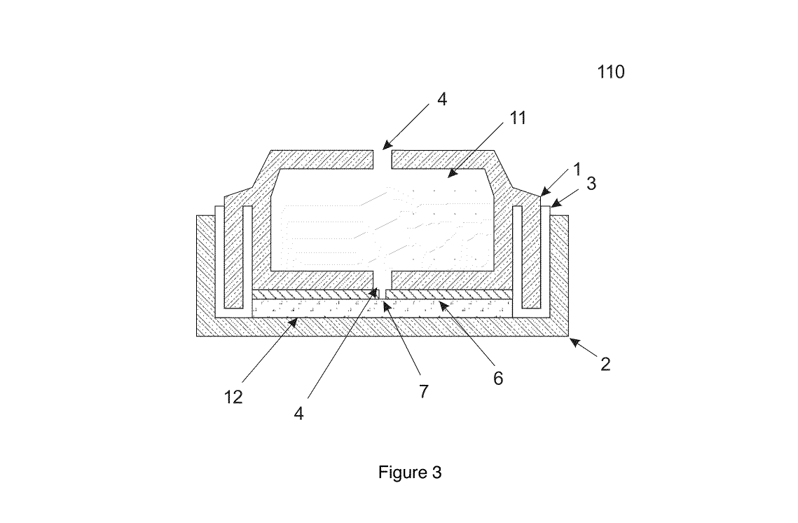

Electrochemical carbon monoxide sensors create a current when carbon monoxide is oxidized at the anode. Any volatile organic vapor that is susceptible to oxidation such as those listed in UL2034 including methane, ethanol, ammonia, etcetera can also generate a current. To minimize and/or prevent such undesired current generation, a particulate and/or activated charcoal filter (Zorflex FM100 by Calgon Carbon Corp.) is preferably associated with electrochemical sensor 100 to prevent false alarms. As is best shown in FIGS. 2-5, filter 11 may be internally contained within housing members 1 and 2. It will be understood that various chemical modifications may be made to the activated charcoal filter to aid in preventing various contaminants from reaching the microelectrode assembly 12. Examples include activated carbon with absorbed potassium permanganate, KMnO₄, to react with reducing gases such as H₂S.

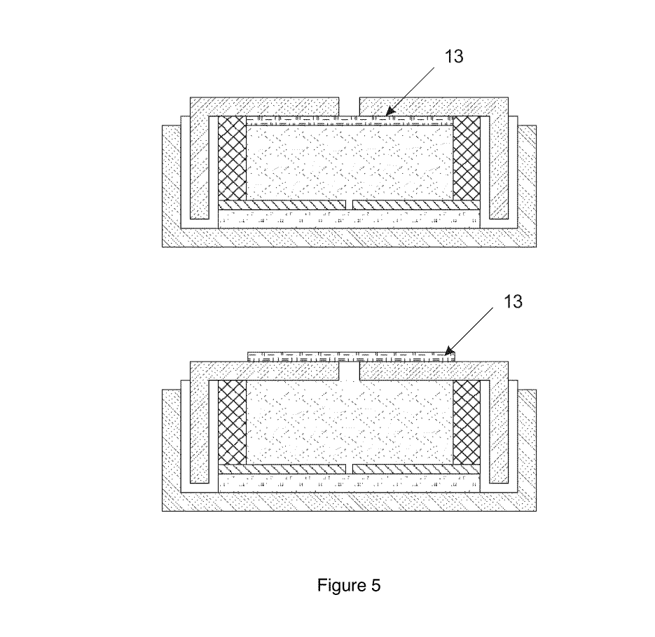

Referring now to FIG. 5, filter 13 may optionally be positioned above and/or below gaseous diffusion aperture or inlet 4 of top housing 1. Materials suitable for such use include but are not limited to expanded polytetrafluoroethylene (ePTFE) such as Gore-Tex™ (W. L. Gore & Associates, Inc.) or microporous polytetrafluoroethylene (mPTFE) such as Mupor™ (Porex Corp.). Filter 13 minimizes and/or prevents liquid water intrusion if the sensor is washed or inadvertently exposed to copious quantities of a liquid.

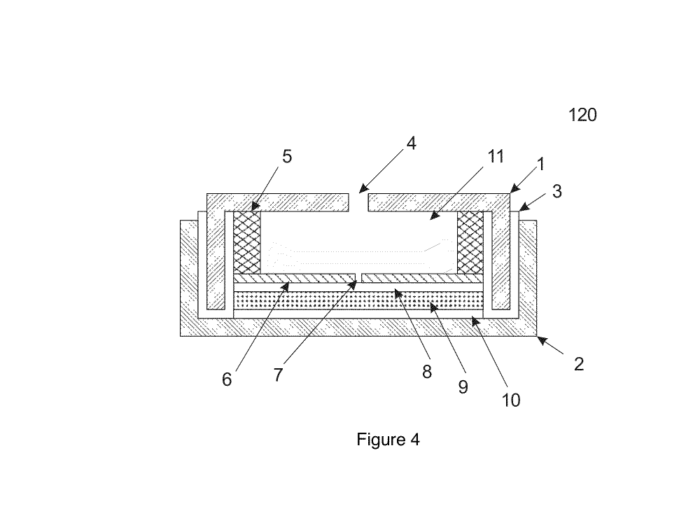

Referring now to FIGS. 4, 7a-7c, and 8 collectively, microelectrode assembly 12 preferably includes anode 8, ion exchange membrane 9 (e.g., polymer electrolyte membrane), and cathode 10. Anode 8 and cathode 10 preferably comprise a catalytic layer 15 and 16, respectively, meeting the requirements of each specific electrode, deposited on a semirigid to rigid electrode support. The electrode supports 19 and 20 are porous to allow for gas diffusion and are typically referred to in the art as gas diffusion layers (GDL). The GDL preferably comprises a carbon paper or carbon cloth (Spectracarb 2050-A, Toray TGP, Ballard AvCarb) that acts as a conductive mechanical support for the various layers in a sensor electrode. The GDL exhibits various levels of conductivity, porosity, and thickness optimized for the required application. A hydrophobic water proofing layer, typically PTFE or fluorinated polyethylene propylene (FEP) may also be applied to the GDL to control water within the electrode. Optionally, a microporous layer (MPL) may be deposited on the GDL to further tune the conductivity, porosity, and hydrophobicity of the electrode support. The MPL preferably comprises a carbon/PTFE layer applied to the GDL layer.

Anode 8 preferably serves as a working or sensing gaseous oxidation electrode, such as a carbon monoxide oxidation electrode. Anode 8 may be fabricated from a catalytic layer 15 deposited onto the aforementioned electrode support 19. The catalytic layer includes a catalyst consisting of transition metals, alloys, and mixtures of the same which are able to catalytically oxidize carbon monoxide, hydrogen, or other volatile organic compounds. This catalyst may be deposited directly on the aforementioned electrode support—for example sputtering a thin film of platinum. In an additional example, platinum and platinum-ruthenium can be associated with a carbonaceous species, such as graphene, carbon black (XC72, BlackPearls), carbon nanotubes (e.g., SWNT, DWNT, MWNT), and combinations thereof, all of which may be modified with atoms such as, but not limited to, nitrogen, boron, and/or phosphorous—utilizing conventional techniques. The carbon may also be modified by various chemical means known to those in the art to create functional groups such as carboxylic acids, amines, etcetera to promote association with the catalytic particles. The carbon surface may also be functionalized with small organic molecules containing the above listed functional groups. One example is 1-aminopyrene (Wang et al., Langmuir 24 (2008) 105050). Additionally, the carbon may be modified with various polymers containing functional moieties that associate readily with the catalytic particles. Non-limiting examples include Pt on polybenzimidazole wrapped MWNT (Okamoto et al., Small, 5 (2009) 735). Optionally, the catalytic metal particles may be associated with various conductive metal oxides (Sasaki et al., ECS Transactions, 33 (2010) 473). A chemical reduction of a catalytic metal salt onto the associated carbon support is a preferred method to prepare the catalyst. The catalytic layer of anode 8 may also be associated with an ion conductor, such as Nafion or acid doped polybenzimidazole, or a binder such as PTFE or FEP in an analogous manner disclosed infra with regard to the working examples of cathode 10. Additional suitable anodic materials include those disclosed in FUEL CELL FUNDAMENTALS, 2^{nd} Ed., O'hayre et al., Wiley (2009), which is hereby incorporated herein by reference in its entirety. The catalytic layer may be deposited onto the electrode support by many means, such as inkjet printing, screen printing, or spraying of a catalyst containing ink.

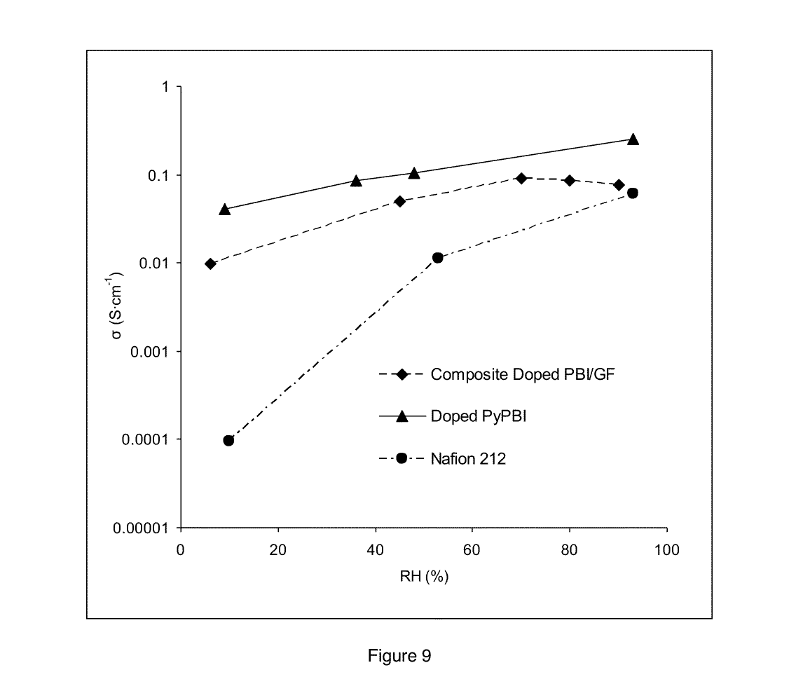

Ion exchange membrane or material 9 generally permits proton or other ion transport (e.g., OH⁻, CO₃²⁻, etcetera) between anode 8 and cathode 10, but generally prevents electron conduction between the same. Non-limiting examples of suitable ion exchange membrane materials include, for example, expanded or microporous PTFE (W. L. Gore, Porex), borosilicate glass fiber membrane, and/or cellulose which may be infused with various ion conducting materials (e.g., acids, bases, protic/protonic ionic liquids, etcetera) such as mineral acids including H₂SO₄ or aqueous alkaline salts such as KOH. Optionally a composite membrane may be used consisting of one of the above membranes combined with an ion conducting polymer including H₃PO₄ doped polybenzimidazoles and derivatives (PBI) (J. S. Wainwright, et al., J. Electrochem. Soc., Vol. 142, No. 7, July 1995), H₃PO₄ doped polypyridylbenzimidazole (PPyBI) and derivatives (L. Xiao, et al., Fuel Cells 5 (2005) 287), protic ionic liquid doped polybenzimidazole derivatives, or protic ionic liquid doped sulfonated polyimide derivatives (S.-Y. Lee, et al., J. Power Sources (2009))—all of which are hereby incorporated herein by reference in their entirety, including all references cited therein. As is shown in FIG. 9 it has been surprisingly discovered that certain configurations of PA-PBI derived ion exchange membranes exhibit high ionic conductivity at very low levels of humidity, even in the complete absence of supplemental humidification of the gas supply. Advantageously, the utilization of such ion exchange membranes in electrochemical sensor 100 allows for the removal of the water tank or reservoir, which makes up a majority of the volume of commercially available electrochemical carbon monoxide sensors. Utilizing these ion exchange membranes avoids the use of corrosive H₂SO₄ which is known to be highly deliquescent even at dilute concentrations. Small amounts of H₃PO₄ bound to an azole-type polymer like PBI are less likely to leak from the ion conducting membrane. Additionally, the foregoing ion conducting membranes exhibit high ionic conductivity, significant resistance to degradation, and are mechanically durable. Other suitable ion exchange membrane materials include solid polymeric electrolytes including, but not limited to, polystyrene sulfonic acid (PSSA) (Sigma-Aldrich) and polyfluorinated sulfonic acids (PFSA) such as Nafion (DuPont), and/or Flemion (Asahi). Composite membranes comprising expanded or microporous PTFE (W. L. Gore, Porex), borosilicate glass fiber membrane, and/or cellulose infused with PSSA or PFSA are also suitable.

Suitable polypyridylbenzimidazoles (PPyBI) doped with Phosphoric Acid are shown structurally below, prepared by Xiao et al., Fuel Cells, 5 (2005) 287.

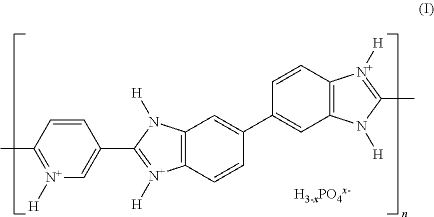

wherein n is an integer ranging in value from 1 to approximately 10,000.

Examples of other suitable polybenzimidazoles that can be modified and/or doped with phosphoric acid are shown structurally below. These may be purchased commercially (PBI Performance Products Inc., FuMaTECH GmbH) or prepared by literature preparations:

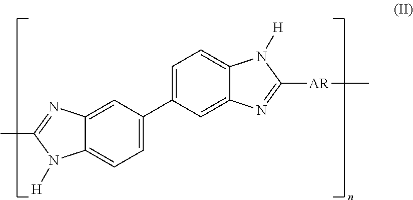

wherein AR comprises at least one of the structures of formulas a-e:

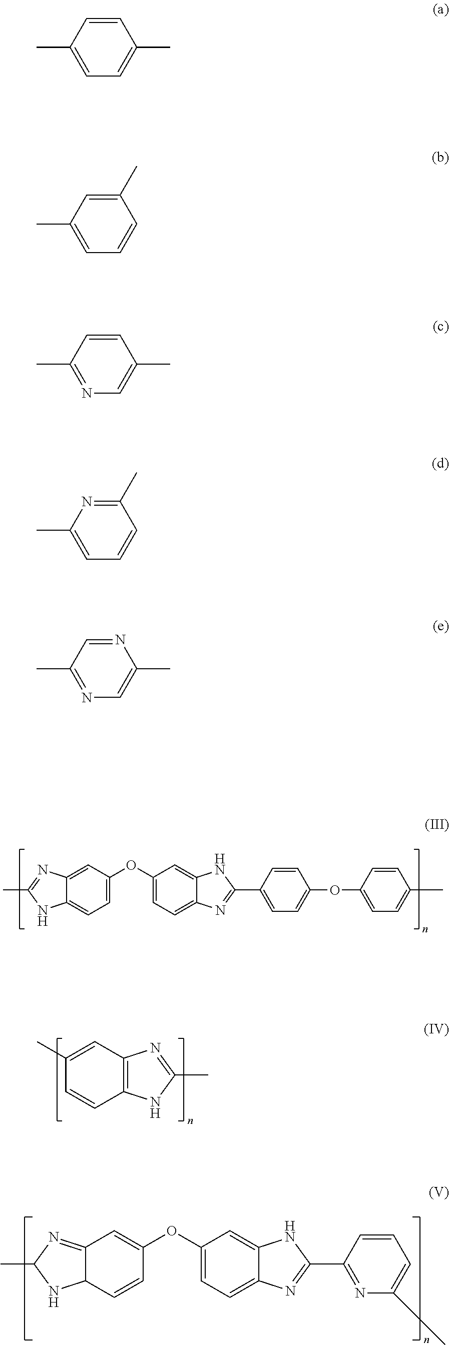

and wherein n is an integer ranging in value from 1 to approximately 10,000.

In accordance with the present invention, ion conducting membrane 9 may be prepared utilizing a plurality of methods, including: (1) post cast doping of commercially available polybenzimidazole derivatives; (2) reaction mixture casting of prepared PBI derivatives doped with phosphoric acid; and (3) post cast doping of a prepared PBI derivative. Composite ion conducting membranes may be prepared similarly.

Ion exchange membrane 9 preferably comprises a thickness ranging from approximately 25 μM to approximately 1000 μM, and more preferably from approximately 25 μM to approximately 250 μM, and may be patterned in any one of a number of configurations—including those disclosed in United States Patent Application Publication Number 2011/0048943.

Preferably cathode 10 comprises a cathodic catalyst layer 16 applied to the surface of the electrode support 20 described herein above in [0035]. The catalyst layer includes a carbonaceous material, such as graphene, carbon black (XC72, Black Pearls), carbon nanotubes (e.g., SWNT, DWNT, MWNT), and combinations thereof, all of which may be modified with atoms such as, but not limited to, nitrogen, boron, and/or phosphorous—utilizing conventional techniques, and an oxygen reduction catalyst associated (i.e., chemically and/or physically) with the carbonaceous material. It will be understood that the carbonaceous material is preferably a catalytically inert, conductive support material fabricated from carbon. It will be further understood that the oxygen reduction catalysts of the present invention are preferably heat treated, pyrolyzed, and/or otherwise activated in a manner that enable the catalysts to remain functionally operable and stable. Notably, the cathodic materials of the present invention preferably do not materially exhibit catalytic activity for the oxidation of carbon monoxide and/or the reduction of carbon dioxide. The catalyst layer of cathode 10 may also be associated with an ion conductor, such as Nafion or acid doped PBI, in an analogous manner disclosed herein. Such electrochemically selective catalysts enable traditional microelectrode assembly configurations (e.g., wherein the anode and the cathode of the microelectrode assembly are disposed upon opposite sides of the ion exchange membrane) and/or exposed to different gaseous environments, as well as novel electrode configurations wherein the anode and the cathode of the microelectrode assembly are disposed upon the same side of the ion exchange membrane and/or exposed to the same gaseous environment. Optionally, the catalyst layer may contain a binder such as PTFE or FEP to modify the water control properties of the layer. The catalytic layer may be deposited onto the electrode support by many means such as inkjet printing, screen printing, or spraying of a catalyst containing ink.

In accordance with one embodiment of the present invention, cathode 10 preferably serves as a counter electrode in the microelectrode assembly and participates in the catalyzed reduction of oxygen to water which was discussed supra.

Non-limiting examples of suitable oxygen reduction catalysts include a material resulting from pyrolysis of substituted, transition metal (i.e., d-block) porphyrins, unsubstituted transition metal porphyrins, substituted transition metal tetrabenzoporphyrins, unsubstituted transition metal tetrabenzoporphyrins, substituted transition metal tetraphenylporphyrins, unsubstituted transition metal tetraphenylporphyrins, substituted transition metal tetraazaporphyrins, unsubstituted transition metal tetraazaporphyrins, substituted transition metal tetraazamacrocycles, unsubstituted transition metal tetraazamacrocycles, substituted transition metal phthalocyanines, unsubstituted transition metal phthalocyanines, substituted transition metal naphthalocyanines, unsubstituted transition metal naphthalocyanines, substituted transition metal bis(phthalocyanines), unsubstituted transition metal bis(phthalocyanines), substituted transition metal bis(naphthalocyanines), unsubstituted transition metal bis(naphthalocyanines), and/or combinations thereof. Examples of preferred transition metals include, but are not limited to, Co, Cu, Fe, Ir, Ni, Pd, Rh, Ru, or Zn, with Co being the most preferred transition metal.

Suitable oxygen reduction catalysts may also be expressed as comprising a material resulting from pyrolysis of a compound, a structural isomer of a compound, and/or mixtures of isomers of compounds, represented by the following structure:

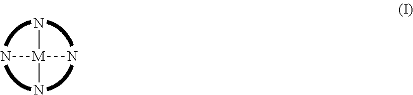

wherein M comprises a transition metal which is ligated by a tetraazamacrocycle, such as, for example, substituted porphyrins, unsubstituted porphyrins, substituted phthalocyanines, unsubstituted phthalocyanines, substituted naphthalocyanines, unsubstituted naphthalocyanines, and combinations thereof.

By way of non-limiting examples, oxygen reduction catalysts may comprise a material resulting from pyrolysis of a compound, a structural isomer of a compound, and/or mixtures of isomers of compounds, represented by the following structure:

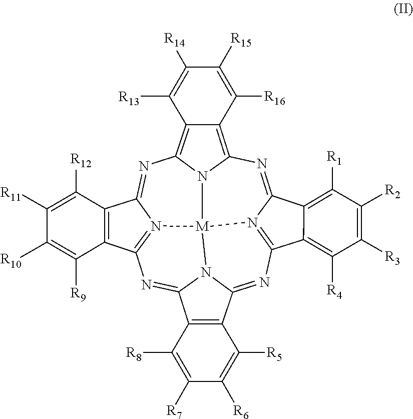

wherein M comprises Co, Cu, Fe, Ir, Ni, Pd, Rh, Ru, or Zn; wherein R₁-R₁₆ are the same or different and comprise H, NO₂, NH₂, NHR₁₇, N(R₁₈)₂, CO₂H, CO₂R₁₉, an alkyl group containing approximately 1 to approximately 10 carbon atom(s), OR₂₀, SH, SR₂₁, and combinations thereof; and wherein R₁₇₋₂₁ are the same or different and comprise an alkyl group containing approximately 1 to approximately 10 carbon atom(s).

Three specific phthalocyanines which serve as oxygen reduction catalysts include:

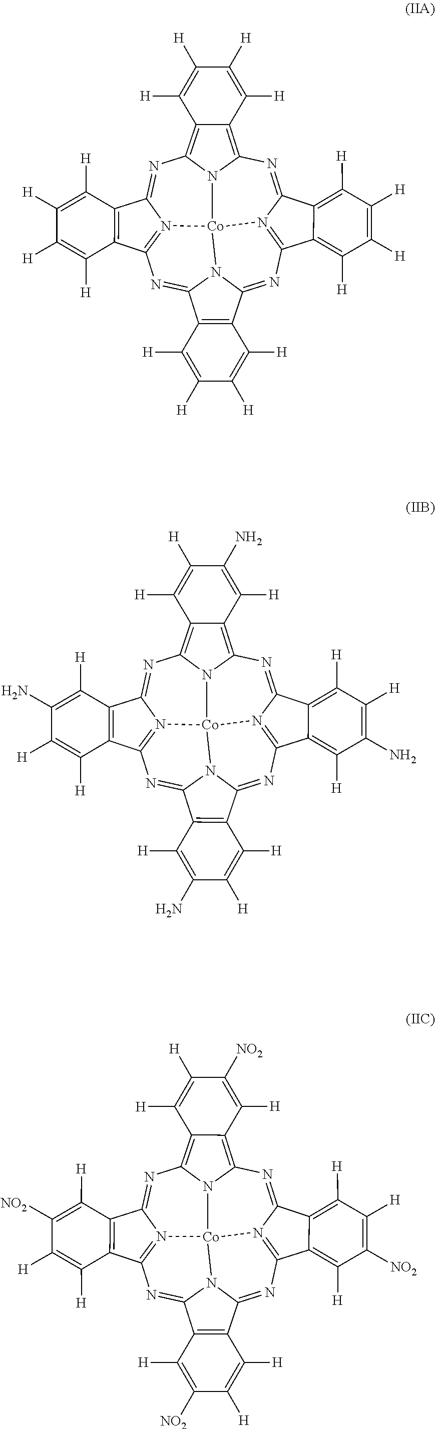

By way of additional non-limiting examples, oxygen reduction catalysts may comprise a material resulting from pyrolysis of a compound, a structural isomer of a compound, and/or mixtures of isomers of compounds, represented by the following formula:

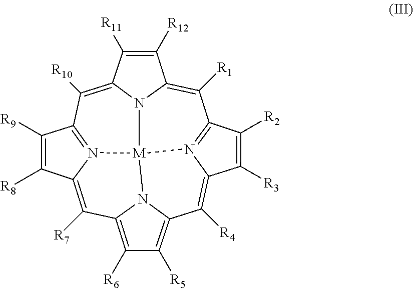

wherein M comprises Co, Cu, Fe, Ir, Ni, Pd, Rh, Ru, or Zn; wherein R₁-R₁₂ are the same or different and comprise H, NO₂, NH₂, NHR₁₃, N(R₁₄)₂, CO₂H, CO₂R₁₅, an alkyl group containing approximately 1 to approximately 10 carbon atom(s), OR₁₆, SH, SR₁₇, and combinations thereof; and wherein R₁₃₋₁₇ are the same or different and comprise an alkyl group containing approximately 1 to approximately 10 carbon atom(s).

In one embodiment of the present invention, the oxygen reduction catalyst comprise a material resulting from pyrolysis of a compound, a structural isomer of a compound, and/or mixtures of isomers of compounds, represented by the following formula:

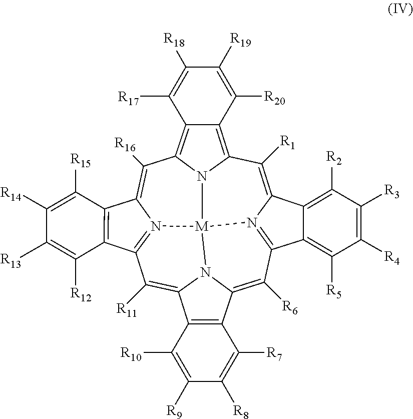

wherein M comprises Co, Cu, Fe, Ir, Ni, Pd, Rh, Ru, or Zn; wherein R₁-R₂₀ are the same or different and comprise H, NO₂, NH₂, NHR₂₁, N(R₂₂)₂, CO₂H, CO₂R₂₃, an alkyl group containing approximately 1 to approximately 10 carbon atom(s), OR₂₄, SH, SR₂₅, and combinations thereof; and wherein R₂₁₋₂₅ are the same or different and comprise an alkyl group containing approximately 1 to approximately 10 carbon atom(s).

In accordance with another embodiment of the present invention, the oxygen reduction catalysts comprises a material resulting from pyrolysis of a compound, a structural isomer of a compound, and/or mixtures of isomers of compounds, represented by the following formula:

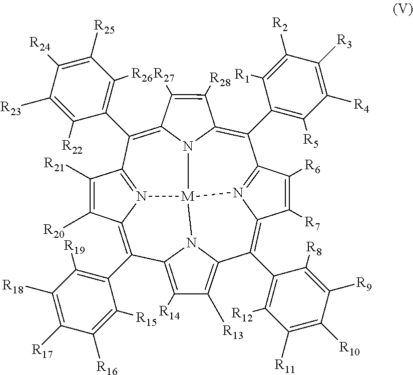

wherein M comprises Co, Cu, Fe, Ir, Ni, Pd, Rh, Ru, or Zn; wherein R₁-R₂₈ are the same or different and comprise H, NO₂, NH₂, NHR₂₉, N(R₃₀)₂, CO₂H, CO₂R₃₁, an alkyl group containing approximately 1 to approximately 10 carbon atom(s), OR₃₂, SH, SR₃₃, and combinations thereof; and wherein R₂₉₋₃₃ are the same or different and comprise an alkyl group containing approximately 1 to approximately 10 carbon atom(s).

In accordance with yet another embodiment of the present invention, the oxygen reduction catalysts comprise a material resulting from pyrolysis of a compound, a structural isomer of a compound, and/or mixtures of isomers of compounds represented by the following formula:

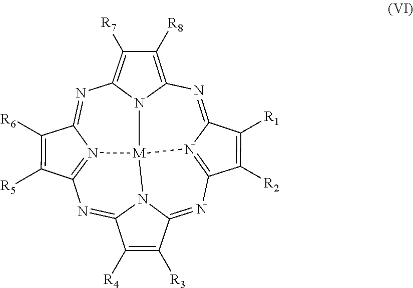

wherein M comprises Co, Cu, Fe, Ir, Ni, Pd, Rh, Ru, or Zn; wherein R₁-R₈ are the same or different and comprise H, NO₂, NH₂, NHR₉, N(R₁₀)₂, CO₂H, CO₂R₁₁, an alkyl group containing approximately 1 to approximately 10 carbon atom(s), OR₁₂, SH, SR₁₃, and combinations thereof; and wherein R₉₋₁₃ are the same or different and comprise an alkyl group containing approximately 1 to approximately 10 carbon atom(s).

It will be understood that several of the above-identified compounds are provided herein as working examples and that additional disclosure for the commercial availability and/or preparation of transition metal porphyrins, tetrabenzoporphyrins, tetraphenylporphyrins, tetraazaporphyrins, tetraazamacrocycles, phthalocyanines, naphthalocyanines, bis(phthalocyanines), and bis(naphthalocyanines), are available from common chemical vendors, such as Sigma-Aldrich Chemical Co., of St. Louis, Mo. and Strem Chemical of Newburyport, Mass.

Without being bound to any one particular theory, it is believed that the metal atom in M-N₄ catalysts disclosed herein contribute to the proper structural formation of the most active carbon-nitrogen catalytic sites during pyrolysis. As such, removal of the metal after pyrolysis using an acid extraction does not appear to adversely affect electrode performance. Suitable acid extraction techniques are provided in, for example, (T. Ikeda, et al., J. Phys. Chem. C 112 (2008) 14706,) (M. Saito et al., 215th ECS Meeting, Abstract #265), and (M. Saito et al., 217th ECS Meeting, Abstract #502)—all of which are hereby incorporated herein by reference in their entirety—including all references cited therein.

In accordance with the present invention, microelectrode assembly 12 may comprise a plurality of configurations, including: (1) a planar configuration; (2) a closed sandwich configuration; and (3) an open sandwich configuration. It will be understood that planar and closed sandwich configurations are disclosed in United States Patent Application Publication Number 2011/0048943.

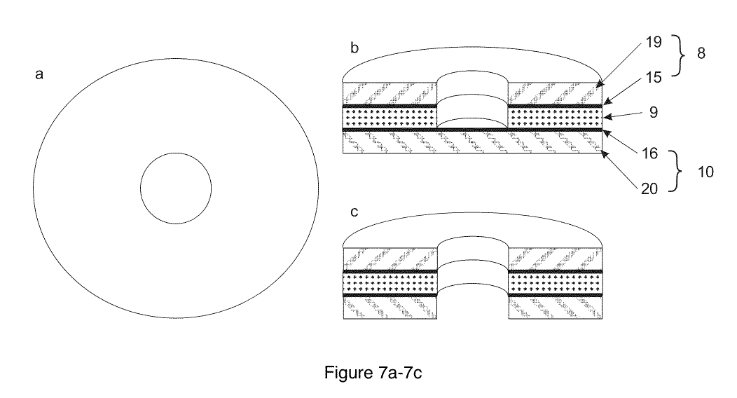

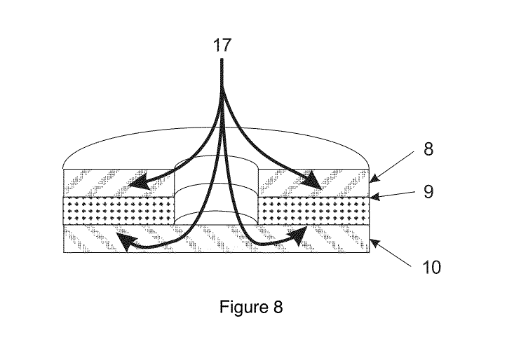

An open sandwich MEA configuration is shown in FIGS. 7a-c and FIG. 8 and uses a chemically specific catalyst discussed in United States Patent Application Publication Number 2011/0048943. In this configuration, both electrodes are exposed to the sample gas containing both carbon monoxide, which can react only at the anode, and oxygen which can react at both electrodes but because of the design only reacts at the cathode. The open sandwich configuration is simple and easily manufactured, and the opening in the anode and electrolyte membrane allows for rapid gas diffusion to both electrodes as the ion exchange membrane limits gas diffusion to the electrode at the opposite end of the inlet hole.

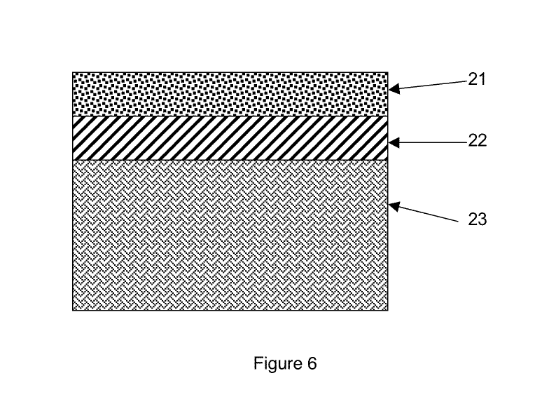

Referring now to FIG. 6, anode 8 and cathode 10, collectively, the electrodes preferably comprise gas diffusion layer (GDL) 23, microporous layer 22, and catalyst layer 21. These combined layers are known to those in the art as a gas diffusion electrode (GDE).

The GDL preferably comprises a carbon paper (Spectracarb 2050-A, Toray TGP, Ballard AvCarb) that acts as a conductive mechanical support for the various layers in a sensor electrode. The GDL comprises various levels of conductivity, porosity, and thickness optimized for the required application, includes a thickness ranging from approximately 25 μM to approximately 1000 μM with approximately 100 μM to approximately 500 μM being a preferred embodiment thickness. It will be understood that the GDL can be laser cut, die cut, etcetera, as desired. The patterning may be done before or after application of various coatings to the electrode.

Commercially available GDLs may come pretreated with a hydrophobic water proofing layer (AvCarb EP40T by AvCarb Material Solutions), typically PTFE or fluorinated polyethylene propylene (FEP) available from DuPont but additional hydrophobic treatment may also be applied to the GDL. Ranges from approximately 5% by weight to approximately 30% by weight are typical.

Commercially available GDLs may come with a microporous layer (MPL) preferably comprised of a carbon/PTFE layer applied to the GDL layer (AvCarb GDS2230 by AvCarb Material Solutions). Optionally, an MPL layer may be applied. Applied MPL typically range in coverage from approximately 0.01 mg/cm² to approximately 10.0 mg/cm², and more preferably from approximately 0.01 mg/cm² to approximately 4.0 mg/cm², depending on the needs of the electrode. Preferred solvents include, but are not limited to, mixtures of water, glycerol, and short and/or long chain alcohols, such as 1-propanol or 1-hexanol. Additionally, high temperature sintering may be utilized to melt any binder material throughout the MPL.

As discussed supra, the catalyst layer may be chemically prepared or comprise sputtered metals, including, for example, platinum (Pt), palladium (Pd), gold (Au), ruthenium (Ru), iridium (Ir), etc. or alloys of the same. It will be understood that the catalyst layer may also include a binder and/or ion conductor (e.g., PTFE, Nafion, etcetera), and one more solvents identified herein. Preferably the weight ratio of binder to catalyst is approximately 5:95 to approximately 1:2.

In accordance with the present invention, microelectrode assembly 12 may be fabricated using any one of a number of conventional techniques, including pad or decal printing, as is disclosed in U.S. Pat. No. 5,211,984, which is hereby incorporated herein by reference in its entirety—including all references cited therein, brushing, screen printing, spraying, ink jet printing, and/or dip coating—just to name a few of the catalyst layers associated with the ion conducting membrane. The GDLs may then be laminated to the catalytic layers. Alternatively, the catalytic layers may be applied to the GDL to form the GDE. The microelectrode assembly may then be fabricated by a heat lamination of the GDEs to the ion conducting membrane through application of both heat and pressure. Temperature ranges are dependent on the materials used and may vary from approximately 50° C. to approximately 200° C., and pressures range from approximately 2 atm to approximately 50 atm.

In accordance with the present invention sensors preferably comply with alarm specifications set forth in UL 2034.

The invention is further described by the following examples.

### Example I

### Preparation of Pt/PTFE Ink Solution

A vial was charged with 285 mg 40 wt % Pt on Carbon Black (Alfa Aesar) followed by 300 mg 5 wt % PTFE suspension (Dupont Inc.) and 900 mg H₂O. This mixture was placed in a bath sonicator for 10 minutes followed by addition of 8.52 g of a solvent mixture consisting of 60% 1-propanol, 20% 1-hexanol, and 20% H₂O. The ink was homogenized with an IKA T-25 Digital Ultra Turrax at 10 k rpm for 30 minutes.

### Example II

### Preparation of Pt/PTFE GDE

A 50 mm×75 mm of AvCarb EP40T (AvCarb Material Solutions) was sintered at 375° C. on a hotplate for 20 minutes. A Pt/PTFE ink solution, 3 wt % solids, was applied evenly across the surface of the GDL using an airbrush with argon carrier gas. The coverage was 0.19 mg catalyst/cm² resulting in a coverage of 0.073 mg Pt/cm². The GDE was dried at 70° C. for 90 minutes under a nitrogen flow then sintered at 375° C. for 20 minutes.

### Example III

### Preparation of PA-abPBI

A 60 mm×60 mm piece of FuMaPEM AM-55 (FuMaTech GMbh) was tared then soaked in 85% H₃PO₄ for 5.5 hours at 100° C. The membrane was removed and excess acid removed by running it between two tightly spaced rollers. Under these conditions, a doping level of approximately 3.1 H₃PO₄ to 1 Benzimidazole repeat unit was achieved.

### Example IV

### Preparation of PA-PBI/Glass Fiber

A solution of 5 wt % PBI in dimethylacetamide (DMAc) was prepared by addition of DMAc to PBI S26 Solution (PBI Performance Products, Inc.). A borosilicate glass fiber membrane (696 grade, VWR Scientific) was soaked in the PBI solution for five hours after which it was removed and excess solution was drained off. The membrane was dried at 120° C. under a nitrogen flow for four hours. To remove the LiCl preservative contained in the PBI S26, the composite membrane was boiled in RO water for two hours during which the water was exchanged three times. The membrane was dried at 120° C. under a nitrogen flow for 30 minutes then soaked in 85% H₃PO₄ for a minimum of 72 hours under ambient conditions. Excess H₃PO₄ was removed by placing the doped composite membrane on a vacuum table and pulling the excess acid off with vacuum.

While the invention has been described in detail herein in accordance with certain preferred embodiments thereof, many modifications and changes therein may be effected by those skilled in the art. Accordingly, it is our intent to be limited only by the scope of the appending claims and not by way of details and instrumentalities describing the embodiments shown herein.

What is claimed and desired to be secured by Letters Patent of the United States is:

1. An electrochemical carbon monoxide sensor for use in a gas/fire detector, comprising:
a housing, wherein the housing comprises a first sidewall, a second sidewall, a top wall, and a bottom wall, and wherein the first sidewall, the second sidewall, the top wall and the bottom wall define a containment region for containing a micro electrode assembly therein, and further wherein the top wall of the housing comprises a gaseous diffusion aperture; and
a micro electrode assembly which comprises an anode, a cathode and an ion conducting membrane, wherein the ion conducting membrane permits ion transport between the anode and the cathode, and wherein the ion conducting membrane prevents electron conduction between the anode and the cathode, and further wherein the ion conducting membrane comprises at least one of an acid doped polybenzimidazole, an acid doped polypyridylbenzimidazole, a protic ionic liquid doped polybenzimidazole, a protic ionic liquid doped sulfonated polyimide, and combinations thereof.

2. The electrochemical carbon monoxide sensor according to claim 1, wherein the ion conducting membrane comprises an acid doped polybenzimidazole, an acid doped polypyridylbenzimidazole, a protic ionic liquid doped polybenzimidazole, a protic ionic liquid doped sulfonated polyimide, and combinations thereof.

3. The electrochemical carbon monoxide sensor according to claim 1, wherein the ion conducting membrane comprises a doped polybenzimidazole.

4. The electrochemical carbon monoxide sensor according to claim 1, wherein the ion conducting membrane comprises an acid doped polybenzimidazole.

5. The electrochemical carbon monoxide sensor according to claim 1, wherein the ion conducting membrane comprises a doped polypyridylbenzimidazole.

6. The electrochemical carbon monoxide sensor according to claim 1, wherein the ion conducting membrane comprises an acid doped polypyridylbenzimidazole.

7. The electrochemical carbon monoxide sensor according to claim 1, wherein the ion conducting membrane comprises a protic ionic liquid doped polybenzimidazole.

8. The electrochemical carbon monoxide sensor according to claim 1, wherein the ion conducting membrane comprises a protic ionic liquid doped sulfonated polyimide.

9. The electrochemical carbon monoxide sensor according to claim 1, wherein the ion conducting membrane comprises the structure of formula I doped with H₃PO₄: 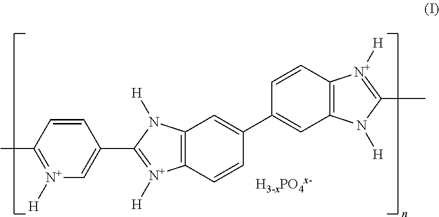
wherein n is an integer ranging in value from 1 to approximately 10,000.

10. The electrochemical carbon monoxide sensor according to claim 1, wherein the ion conducting membrane comprises the structure of formula II doped with H₃PO₄: 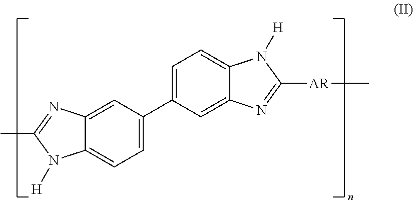
wherein AR comprises at least one of the structures of formulas a-e: 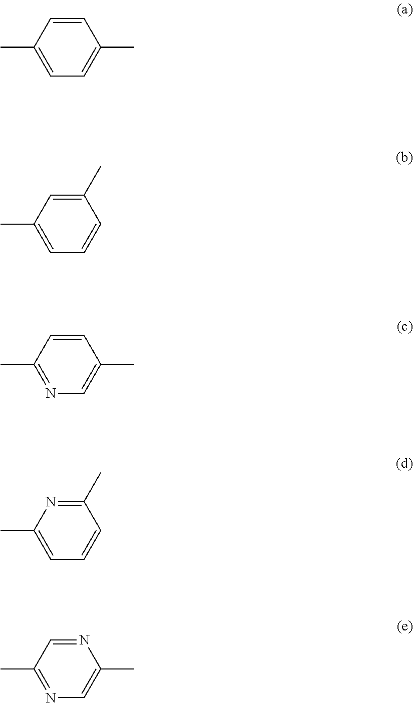
and wherein n is an integer ranging in value from 1 to approximately 10,000.

11. The electrochemical carbon monoxide sensor according to claim 1, wherein the ion conducting membrane comprises the structure of formula III doped with H₃PO₄: 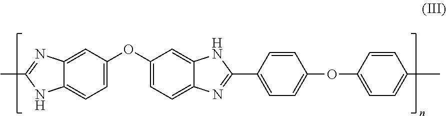
wherein n is an integer ranging in value from 1 to approximately 10,000.

12. The electrochemical carbon monoxide sensor according to claim 1, wherein the ion conducting membrane comprises the structure of formula IV doped with H₃PO₄: 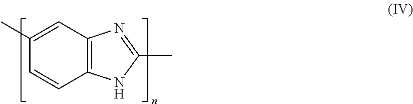
wherein n is an integer ranging in value from 1 to approximately 10,000.

13. The electrochemical carbon monoxide sensor according to claim 1, wherein the ion conducting membrane comprises the structure of formula V doped with H₃PO₄: 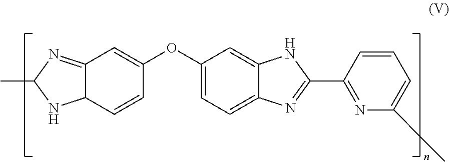
wherein n is an integer ranging in value from 1 to approximately 10,000.

14. The electrochemical carbon monoxide sensor according to claim 1, wherein the electrochemical sensor is at least one of tankless and reservoir free.

15. The electrochemical carbon monoxide sensor according to claim 14, wherein the electrochemical sensor comprises at least one of a button cell and a coin cell.

16. The electrochemical carbon monoxide sensor according to claim 14, wherein the anode and the cathode are disposed upon opposite sides of the ion conducting membrane.

17. The electrochemical carbon monoxide sensor according to claim 14, wherein the anode and the cathode are disposed upon a same side of the ion conducting membrane.

18. The electrochemical carbon monoxide sensor according to claim 14, wherein the anode and the cathode are exposed to a same gaseous environment.

19. An electrochemical carbon monoxide sensor for use in a gas/fire detector, comprising:
a housing, wherein the housing comprises a first sidewall, a second sidewall, a top wall, and a bottom wall, and wherein the first sidewall, the second sidewall, the top wall and the bottom wall define a containment region for containing a micro electrode assembly therein, and further wherein the top wall of the housing comprises a gaseous diffusion aperture; and
a micro electrode assembly which comprises an anode, a cathode and an ion conducting membrane, wherein the anode and the cathode are exposed to a same gaseous environment, and wherein the ion conducting membrane permits ion transport between the anode and the cathode, and wherein the ion conducting membrane prevents electron conduction between the anode and the cathode, and further wherein the ion conducting membrane comprises a polybenzimidazole doped with at least one of an acid, a base, and a protic ionic liquid.

20. An electrochemical carbon monoxide sensor for use in a gas/fire detector, comprising:
a housing, wherein the housing comprises a first sidewall, a second sidewall, a top wall, and a bottom wall, and wherein the first sidewall, the second sidewall, the top wall and the bottom wall define a containment region for containing a micro electrode assembly therein, and further wherein the top wall of the housing comprises a gaseous diffusion aperture; and
a micro electrode assembly which comprises an anode, a cathode and an ion conducting membrane, wherein the anode and the cathode are exposed to a same gaseous environment, and wherein the ion conducting membrane permits ion transport between the anode and the cathode, and wherein the ion conducting membrane prevents electron conduction between the anode and the cathode, and further wherein the ion conducting membrane comprises a polypyridylbenzimidazole doped with at least one of an acid, a base, and a protic ionic liquid.
